(19) United States
(12) Patent Application Publication
(10) Pub. No.: US 2026/0005953 A1
(43) Pub. Date: Jan. 1, 2026

(54) IP PERFORMANCE MEASUREMENT EXTENSION FOR FASTER CONVERGENCE WITH MULTIHOMING

(71) Applicant: Cisco Technology, Inc., San Jose, CA (US)

(72) Inventors: Mankamana Prasad Mishra, San Jose, CA (US); Frank Brockners, Cologne (DE); Rakesh Gandhi, Ontario (CA); Nitin Kumar, San Jose, CA (US)

(21) Appl. No.: 18/757,318

(22) Filed: Jun. 27, 2024

(51) Int. Cl. H04L 45/12; H04L 45/28; H04L 45/76

(52) U.S. Cl. CPC H04L 45/123; H04L 45/28; H04L 45/76

(57) ABSTRACT

A system and method are provided for faster convergence with multihoming using internet protocol (IP) performance measurement (PM) sessions to report, to a transmitting provider edge (PE), a state of health of a connection between a multihomed node and a receiving (PE). The state of health can be the liveness of the connection. The receiving PE locally monitors the state of health of its connection to the node, and encodes information of the state of health in a field of the PM session messages sent to the transmitting PE. For example, while the PM session messages indicate the connection is live, traffic from the transmitting PE to the node is routed through the receiving PE. Upon the PM session messages indicating the connection is no longer live, the transmitting PE instead routes traffic to the node through another receiving PE with which the node is multihomed.

### BACKGROUND

EVPN stands for Ethernet Virtual Private Network. This is an extension of BGP that enables the signaling of bridged (L2) and routed (L3) VPNs over a common network. EVPN is described in RFC 7432 and is updated by several additional RFCs and IETF drafts including RFC 9135 (Integrated Routing and Bridging in Ethernet VPN), RFC 9136 (IP Prefix Advertisement in Ethernet VPN), RFC 8584 (Framework for Ethernet VPN Designated Forwarder Election Extensibility), and RFC 8365 (A Network Virtualization Overlay Solution Using Ethernet VPN). FRR supports All-Active Layer-2 Multihoming for devices (MHD) via LACP Ethernet Segments as well as both Symmetric and Asymmetric IRB. FRR implements MAC-VRFs using a “VLAN-Based Service Interface” (RFC 7432) and performs processing of Symmetric IRB routes following the “Interface-less IP-VRF-to-IP-VRF Model” (RFC 9136).

BGP-EVPN is the control plane for the transport of Ethernet frames, regardless of whether those frames are bridged or routed. In the case of a VLAN-Based Service Interface with VXLAN encapsulation, a single VNI is used to represent an EVPN Instance (EVI) and will have its own Route Distinguisher and set of Import/Export Route-Targets.

A VNI can be either an OSI Layer-2 interface (e.g., tied to a MAC-VRF) or can be an OSI Layer-3 interface (e.g., tied to an IP-VRF), which indicates what kind of information is represented by the VRF. An IP-VRF represents a routing table (e.g., operating in much the same way as a VRF traditionally operates in a Layer-3 VPN), while a MAC-VRF represents a bridging table, such as, MAC forwarding database and ARP/NDP entries.

FRR learns about the system's Linux network interface configuration from the kernel via Netlink, however it does not manage network interfaces directly.

An Ethernet segment(ES) is a set of Ethernet links that connects a multihomed device. If a multi-homed device or network is connected to two or more PEs through a set of Ethernet links, then that set of links is referred to as an ES. When a failure occurs at an ES (e.g., a connection fails between the multi-homed device one of the PEs) BGP delays in notifying a transmitting PE can cause various problems, such as slow convergence and oversubscription.

Accordingly, an improved solution is desired for more quickly notifying the transmitting PE when there is a failure at an ES.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a block diagram of a first example of a network, in accordance with certain embodiments.

FIG. 1B illustrates a block diagram of a second example of the network, in accordance with certain embodiments.

FIG. 2 illustrates an example of an overlay network on an underlay network, in accordance with some embodiments.

FIG. 3 illustrates a block diagram of an example of routing data traffic to multihomed nodes, in accordance with some embodiments.

FIG. 4 illustrates an example of a method for realizing faster convergence with multihoming based on liveness reporting using a performance measurement session, in accordance with some embodiments.

FIG. 5 illustrates a block diagram of an example of advertising a bit position corresponding to a data link, in accordance with some embodiments.

FIG. 6 illustrates a block diagram of an example of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Abbreviations

The following abbreviations and acronyms are used herein:
“VPN” refers to “virtual private network”
“EVPN” refers to “Ethernet virtual private network”
“PE” refers to “provider edge”
“CE” refers to “customer edge”
“PM” refers to “performance measurement”
“BGP” refers to ““border gate protocol”
“IGP” refers to “interior gate protocol”
“VM” refers to “virtual machine”
“TLV” refers to “type-length-value”
“OWAMP” refers to “one-way active measurement protocol”
“TWAMP” refers to “two-way active measurement protocol”
“STAMP” refers to “simple two-way active measurement protocol”
“ES” refers to “Ethernet segment”
“EC field 512” refers to “extended community”
“DF” refers to “designated forwarder”
“BUM” refers to “broadcast, unknown-unicast and multicast”
“ESI” refers to “Ethernet segment identifier”
“EVI” refers to “EVPN instance”
“VNI” refers to “virtual network identifier”
“EAD/ES” refers to “Ethernet auto discovery route per ES”
“VXLAN” refers to “Virtual extensible Local-Area Network”
“VTEP” refers to “VXLAN tunnel end point”
“VNID” refers to “VXLAN network identifier”
“IETF” refers to “IETF”
“RFC” refers to “Request for Comments to the IETF”
“IP” refers to “Internet protocol”
“MHD” refers to “multihoming for devices”
“VLAN” refers to “virtual local area network”
“MAC” refers to “medium access control”
“FFR” refers to “fast reroute”
“VRF” refers to “virtual routing and forwarding”
“LACP” refers to “link aggregation control protocol”
“IRB” refers to “integrated routing and bridging”
“CPU” refers to “central processing unit”
“TCP” refers to “transmission control protocol”
“IP” refers to “Internet protocol”
“UDP” refers to “user datagram protocol”
“OS” refers to “operating system”
“IPv6” refers to “Internet protocol version 6”
“ASIC” refers to “application-specific integrated circuit”
“FPGA” refers to “field programable gate array”
“TOR” refers to “top of rack”
“Geneve” refers to “generic network virtualization encapsulation”
“HTTP” refers to “hypertext transfer protocol”
“HTTPS” refers to “hypertext transfer protocol secure”
“OSPF” refers to “open shortest path first”
“EIGRP” refers to “enhanced interior gateway routing protocol”
“RU” refers to “rack unit”
“VLAN” refers to “virtual local area network”
“ROM” refers to “read-only memory”
“RAM” refers to “random access memory”
“API” refers to “application programming interface”
“BFD” refers to “bidirectional forwarding detection”
“CFM” refers to “connectivity fault management”
“MPLS” refers to “multiprotocol label switching”
“DC” refers to “data center”
“OSI” refers to “open systems interconnection”
“L2” refers to “layer 2 of the OSI model”
“L3” refers to “layer 3 of the OSI model”
“L7” refers to “layer 7 of the OSI model”
“VNF” refers to “virtual network function”
“ARP” refers to “address resolution protocol”
“SONET” refers to “synchronous optical networks”
“SDH” refers to “synchronous digital hierarchy”
“PLC” refers to “Powerline Communications”
“NMS” refers to “network management system”
“DHCP” refers to “dynamic host configuration protocol”
“CoAP” refers to “constrained application protocol”
“OMS” refers to “outage management system”
“APIC” refers to “application policy infrastructure controller”

### Overview

In some aspects, the techniques described herein relate to a method including: signaling, from a first provider edge device, an extension to a virtual-network protocol, the extension defining a first unique identifier corresponding to a node connected to the first provider edge device; monitoring, by the first provider edge device, one or more states associated with the node; initiating a performance measurement session between the first provider edge device and a second provider edge device, and the performance measurement session includes sending one or more messages having a field that encodes state information representing the one or more states associated with the node; and sending, from the first provider edge device, the one or more messages to the second provider edge device, wherein traffic from the second provider edge device to the node are routed along a path that includes the first provider edge device.

In some aspects, the techniques described herein relate to a method, wherein the one or more states associated with the node are a state of an ethernet segment that connects the node with the first provider edge device, host states of one or more hosts on the node, application states of one or more applications running on the node, or VM states of one or more virtual machines (VMs) on the node.

In some aspects, the techniques described herein relate to a method, wherein a first ethernet segment connects the node to the first provider edge device, and the one or more states associated with the node are a liveness state of the first ethernet segment.

In some aspects, the techniques described herein relate to a method, wherein the first unique identifier is manually provisioned.

In some aspects, the techniques described herein relate to a method, wherein the first unique identifier is provisioned by a controller.

In some aspects, the techniques described herein relate to a method, wherein: the virtual-network protocol is an Ethernet virtual private network (EVPN) protocol on an VXLAN virtual network, the performance measurement session is initiated using a protocol selected from a group consisting of a Two-Way Active Measurement Protocol (TWAMP), a Simple Two-Way Active Measurement Protocol (STAMP), bi-directional forwarding (BFD) protocol, the one or more messages are messages of the internet protocol (IP) performance measurement (PM) session, and the field is a type-length-value field that includes a value representing whether a failure has occurred with respect to the node, and monitoring the one or more states associated with the node is performed using a local optics check for an interface failure, a local connectivity fault management (CFM) protocol, a bi-directional forwarding detection (BFD) protocol, or a local IP-PM session (also referred to by the abbreviation PM session).

In some aspects, the techniques described herein relate to a method, wherein the node is multihomed at the first provider edge device and a third provider edge device, and the node is advertised, via the virtual-network protocol, to the second provider edge device as receiving traffic either through the first provider edge device or through the third provider edge device.

In some aspects, the techniques described herein relate to a method, wherein, when the state information indicates a failure of a connection between the first provider edge device and the node, ceasing to receive the traffic along the path from the second provider edge device to the node including the first provider edge device, and receiving the traffic along another path from the second provider edge device to the node including the third provider edge device.

In some aspects, the techniques described herein relate to a method, wherein: the node is a client-edge device that is connected to one or more hosts, monitoring one or more states state associated with the node includes monitoring liveness states of the one or more hosts, and sending the state information includes intermittently sending current liveness states of the one or more hosts in the one or more messages.

In some aspects, the techniques described herein relate to a method, wherein: the one or more messages are messages sent in the performance measurement session that encode the state information of the liveness states using respective binary values in the field of the messages, wherein a binary value at a first bit location in the field represents a state of a first host of the one or more host, a live state of the first host being represented by a first binary value at the first bit location, and a non-live state of the first host being represented by a second binary value at the first bit location.

In some aspects, the techniques described herein relate to a method, wherein initiating the performance measurement session between the first provider edge device and the second provider edge device includes defining which of the one or more hosts correspond to which bit locations in the field of the messages sent in the performance measurement session.

In some aspects, the techniques described herein relate to a method including: receiving, at a second provider edge device, a signal including one or more instructions to apply an extension to a virtual-network protocol, the extension defining a first unique identifier corresponding to a node connected to a first provider edge device; instantiating a performance measurement session between the second provider edge device and the first provider edge device, wherein the performance measurement session includes receiving at the second provider edge device one or more messages having a field that encodes state information representing one or more states associated with the node; sending traffic from the second provider edge device to the node, wherein the traffic are routed on a path from the second provider edge device to the node including the first provider edge device; and performing, at the second provider edge device, a failover action when a value of the field indicates a failure associated with the node or degradation of communications between the first provider edge device and the node.

In some aspects, the techniques described herein relate to a method, further including: receiving, at the second provider edge device, information that the node is multihomed with the first provider edge device and a third provider edge device, such that a first ethernet segment connects the node to the first provider edge device, a second first ethernet segment connects the node to the third provider edge device; and performing the failover action includes: ceasing to send the traffic via the path from the second provider edge device to the node including the first provider edge device; and sending, from the second provider edge device, the traffic via another path from the second provider edge device to the node including the third provider edge device.

In some aspects, the techniques described herein relate to a method, wherein: the node is multihomed with the first provider edge device and with a third provider edge device, and the failover action is for the second provider edge device to direct traffic to the third provider edge device, when the one or more messages indicate the failure of communication between the first provider edge device and the node.

In some aspects, the techniques described herein relate to a method, wherein the failover action is performed when the value of the field indicates the failure associated with the node is (i) an absence of communication between the first provider edge device and the node, (ii) an indication of non-liveness of a first ethernet segment between the node and the first provider edge device, (iii) an indication of traffic loss between the first provider edge device and the node has exceeded a first predefined threshold, or (iv) an indication of jitter between the first provider edge device and the node has exceeded a second predefined threshold.

In some aspects, the techniques described herein relate to a system including: a first provider edge device including: a first processor; and a first memory storing instructions that, when executed by the first processor, configure the first provider edge device to: signal, to a second provider edge device, an extension to a virtual-network protocol, the extension defining a first unique identifier corresponding to a node connected to the first provider edge device; monitor one or more states associated with the node; initiate a performance measurement session between the first provider edge device and a second provider edge device, wherein the performance measurement session includes sending one or more messages having a field that encodes state information representing the one or more states associated with the node; and send, to the second provider edge device, the one or more messages to the second provider edge device, wherein traffic from the second provider edge device to the node are routed along a path that includes the first provider edge device.

In some aspects, the techniques described herein relate to a system, wherein the one or more states associated with the node are a state of an ethernet segment that connects the node with the first provider edge device, states of one or more hosts on the node, states of one or more applications on the node, or states of one or more virtual machines on the node.

In some aspects, the techniques described herein relate to a system, wherein the one or more states associated with the node are a state of an ethernet segment that connects the node with the first provider edge device, states of one or more hosts on the node, states of one or more applications on the node, or states of one or more virtual machines on the node.

In some aspects, the techniques described herein relate to a system, wherein the first unique identifier is manually provisioned.

In some aspects, the techniques described herein relate to a system, wherein the first unique identifier is provisioned by a controller.

In some aspects, the techniques described herein relate to a system, wherein: the virtual-network protocol is an Ethernet virtual private network (EVPN) protocol on an VXLAN virtual network, the performance measurement session is initiated using a protocol selected from a group consisting of a Two-Way Active Measurement Protocol (TWAMP), a Simple Two-Way Active Measurement Protocol (STAMP), bi-directional forwarding (BFD) protocol, the one or more messages are messages of the performance measurement session, and the messages include a type-length-value field that includes a value representing whether a failure has occurred with respect to the node, and monitoring the one or more states associated with the node is performed using a local optics check for an interface failure, a local connectivity fault management (CFM) protocol, a bi-directional forwarding detection (BFD) protocol, or a local performance measurement session.

In some aspects, the techniques described herein relate to a system, wherein the node is multihomed at the first provider edge device and a third provider edge device, and the node is advertised, via the virtual-network protocol, to the second provider edge device as receiving the traffic either through the first provider edge device or through the third provider edge device.

In some aspects, the techniques described herein relate to a system, wherein, the instructions stored in the first memory further configure the first provider edge device such that, when the state information encoded in the one or more messages indicates a failure of a connection between the first provider edge device and the node, the first provider edge device is configured to: cease to receive the traffic along the path from the second provider edge device to the node including the first provider edge device, and receive the traffic along another path from the second provider edge device to the node including the third provider edge device.

In some aspects, the techniques described herein relate to a system, wherein: the node is a client-edge device that is connected to one or more hosts, monitoring one or more states state associated with the node includes monitoring liveness states of the one or more hosts, and signaling the state information representing the one or more states associated with the node includes intermittently signaling current liveness states of the one or more hosts.

In some aspects, the techniques described herein relate to a system, wherein the one or more messages are messages sent in the performance measurement session that encode information of the liveness states using respective binary values in a field of the messages, wherein a binary value at a first bit location in the field represents a state of a first host of the one or more host, a live state of the first host being represented by a first binary value at the first bit location, and a non-live state of the first host being represented by a second binary value at the first bit location.

In some aspects, the techniques described herein relate to a system, wherein, the instructions stored in the first memory further configure the first provider edge device to: initiate the performance measurement session between the first provider edge device and the second provider edge device includes defining which of the one or more hosts correspond to which bit locations in the field of the messages sent in the performance measurement session.

In some aspects, the techniques described herein relate to a system, further including: a second provider edge device including: a second processor; and a second memory storing instructions that, when executed by the second processor, configure the second provider edge device to: receive, from the first provider edge device, a signal including one or more instructions to apply the extension to the virtual-network protocol; instantiate the performance measurement session between the second provider edge device and the first provider edge device; send the traffic to the node, the traffic being routed along the path from the second provider edge device to the node including the first provider edge device; receive, from the first provider edge device, the one or more messages; and perform a failover action when the state information encoded in the field of the one or more messages indicates a failure associated with the node or a degradation of communications between the first provider edge device and the node.

In some aspects, the techniques described herein relate to a system, wherein: the node is multihomed with the first provider edge device and with a third provider edge device, and the failover action is for the second provider edge device to direct the traffic to the third provider edge device, when the one or more messages indicate the failure of communication between the first provider edge device and the node.

In some aspects, the techniques described herein relate to a system, wherein the failover action is performed when the field indicates the failure associated with the node is (i) an absence of communication between the first provider edge device and the node, (ii) an indication of non-liveness of a first ethernet segment between the node and the first provider edge device, (iii) an indication of traffic loss between the first provider edge device and the node has exceeded a first predefined threshold, or (iv) an indication of jitter between the first provider edge device and the node has exceeded a second predefined threshold.

In some aspects, the techniques described herein relate to a second provider edge device including: a processor; and a memory storing instructions that, when executed by the processor, configure the second provider edge device to: receive, from a first provider edge device, a signal including one or more instructions to apply an extension to a virtual-network protocol, the extension defining a first unique identifier corresponding to a node connected to a first provider edge device; instantiate performance measurement session between the second provider edge device and the first provider edge device, wherein the performance measurement session includes receiving one or more messages having a field that encodes state information representing one or more states associated with the node; send traffic to the first node, the traffic being routed along a path from the second provider edge device to the node including the first provider edge device; receive, from the first provider edge device, the one or more messages; and perform a failover action when a value of the state information encoded in the field of the one or more messages indicates a failure associated with the node or a degradation of communications between the first provider edge device and the node.

In some aspects, the techniques described herein relate to a second provider edge device, wherein: the node is multihomed with the first provider edge device and with a third provider edge device, and the failover action is for the second provider edge device to direct the traffic to the third provider edge device, when the one or more messages indicate the failure of communication between the first provider edge device and the node.

In some aspects, the techniques described herein relate to a second provider edge device, wherein the failover action is performed when the value of the field indicates the failure associated with the node is (i) an absence of communication between the first provider edge device and the node, (ii) an indication of non-liveness of a first ethernet segment between the node and the first provider edge device, (iii) an indication of traffic loss between the first provider edge device and the node has exceeded a first predefined threshold, or (iv) an indication of jitter between the first provider edge device and the node has exceeded a second predefined threshold.

In some aspects, the techniques described herein relate to a non-transitory computer-readable storage medium, the computer-readable storage medium including instructions that when executed by a computer, cause the computer to: signal, from a first provider edge device, an extension to a virtual-network protocol, the extension defining a first unique identifier corresponding to a node connected first provider edge device; monitor, by the first provider edge device, one or more states associated with the node; initiate a performance measurement session between the first provider edge device and a second provider edge device, and the performance measurement session includes sending one or more messages having a field that encodes information representing the one or more states associated with the node; and send, from the first provider edge device, the one or more messages to the second provider edge device, wherein traffic from the second provider edge device are routed to the node through the first provider edge device.

In some aspects, the techniques described herein relate to a non-transitory computer-readable storage medium, the computer-readable storage medium including instructions that when executed by a computer, cause the computer to: receive, at a second provider edge device, a signal including one or more instructions to apply an extension to a virtual-network protocol, the extension defining a first unique identifier corresponding to a node connected to a first provider edge device; instantiate a performance measurement session between the second provider edge device and the first provider edge device, wherein the performance measurement session includes receiving one or more messages having a field that indicates one or more states associated with the node; send, to the node, traffic from the second provider edge device, wherein the traffic are routed along a path from the second provider edge device to the node including the first provider edge device; receive, at the second provider edge device, a packet of the one or more messages that indicates a value of the field for the one or more states associated with the node; and perform, at the second provider edge device, a failover action when the value of the field indicates a failure associated with the node or a degradation of communications between the first provider edge device and the node.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for faster convergence with multihoming upon the failure at an Ethernet segment(ES). Without the systems and methods disclosed herein, a failure at an ES (e.g., a connection fails between the multi-homed device one of the PEs) can result in BGP delays for notifying a transmitting PE, causing various problems such as slow convergence and oversubscription.

For example, a node (e.g., a CE) can be multihomed with a first PE, such that network traffic from a second PE to the node is initially routed through the first PE. The node can also be multihomed with a third PE, such that upon failure of the connection between the node and the first PE, network traffic to the node can be rerouted through the third PE. To provide prompt notification of the connection failure of the second PE, the systems and methods disclosed herein establish an internet protocol (IP) performance measurement session (PM) session (e.g., an IP-PM session can also be abbreviated as PM session) between the first PE and the second PE. The PM session messages from the first PE and the second PE include a field (e.g., a TLV field in a STAMP test packet) that conveys the state of health information. For example, the state of health can be represented by a bit value at a predefined bit location within the field, and this bit value can represent the liveness of the connection between the node and the first PE. When the second PE receives a PM session message indicating that connection between the node and the first PE is no longer live, the second PE can promptly direct traffic through the third PE, rather than the first PE.

A computer network is a geographically distributed collection of nodes interconnected by communication links and segments for transporting data between end nodes, such as personal computers, cellular phones, workstations, or other devices, such as sensors, etc. Many types of networks are available, with types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

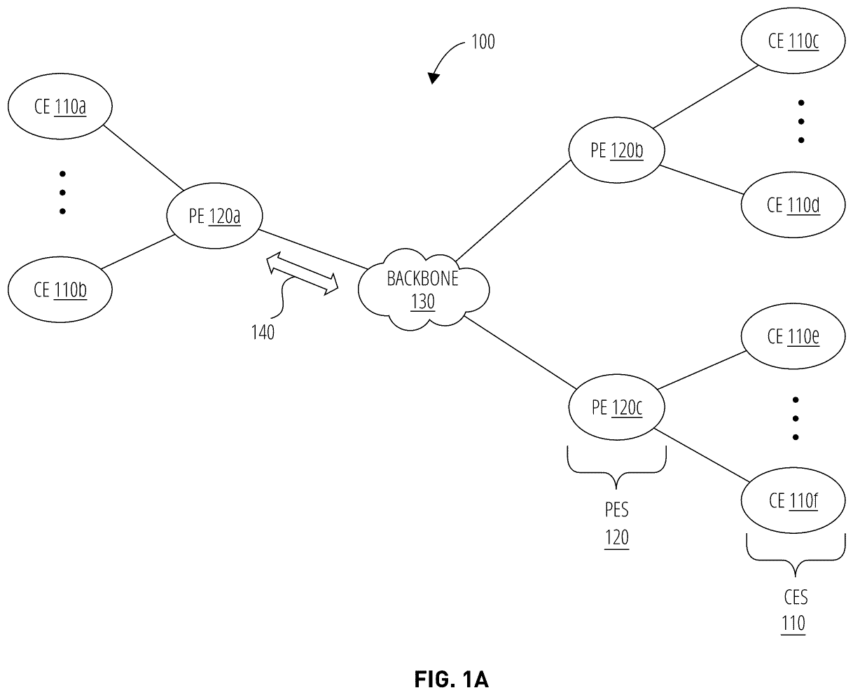

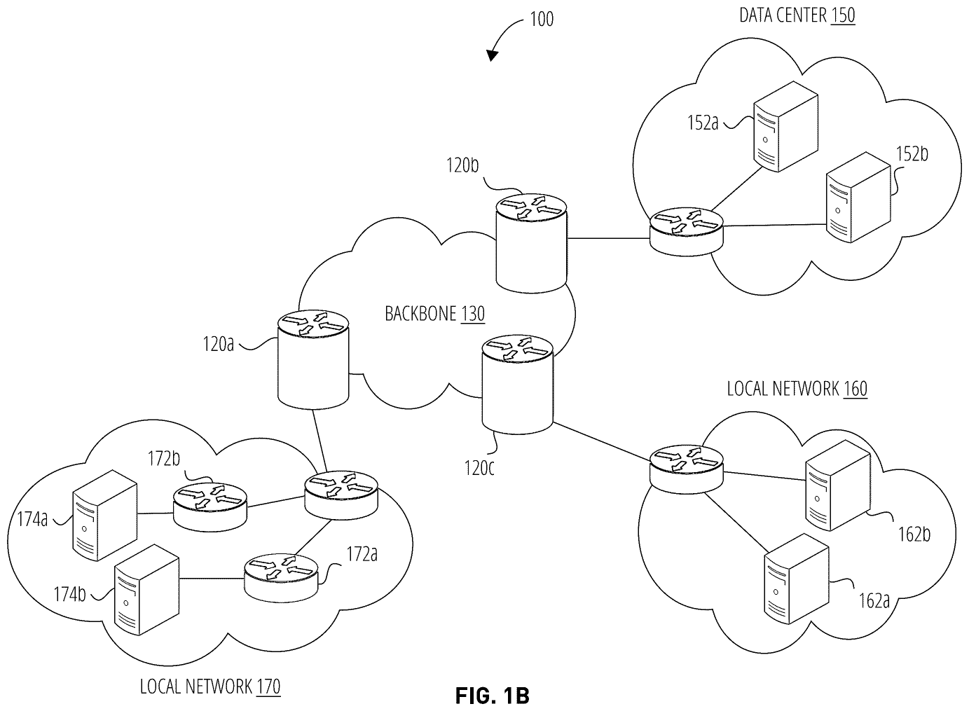

FIG. 1A is a schematic block diagram of a non-limiting example of a computer network 100 that includes various nodes/devices, such as a plurality of routers/devices interconnected by links or networks. For example, customer edge (CE) routers/devices, which are referred to collectively as CEs 110, (e.g., CE 110a, CE 110b, CE 110c, CE 110d, CE 110e, and CE 110f) may be interconnected with provider edge (PE) routers/devices, which are referred to collectively as PEs 120 (e.g., PE 120a, PE 120b, and PE 120c), to communicate across a core network, such as a network backbone 130. For example, the routers (e.g., CEs 110, PEs 120) may be interconnected by the public Internet, a multiprotocol label switching (MPLS), or a virtual private network (VPN). Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

According to certain non-limiting examples, a given customer site may fall under one or more of the following categories:

1.) Site Type A: a site connected to the network (e.g., via a private or VPN link) using a single CE router and a single link, with potentially a backup link (e.g., a 3G/4G/5G/LTE backup connection). For example, a particular CE router shown in computer network 100 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE 120c and via a separate Internet connection, potentially also with a wireless backup link.

2c.) Site Type B3: a site connected to the network using two links connected to the public Internet, with potentially a backup link (e.g., a 3G/4G/5G/LTE connection).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE 110c) connected to PE 120b and a second CE router (e.g., CE 110e) connected to PE 120c.

FIG. 1B illustrates an example of computer network 100 in greater detail, according to various embodiments. As shown, network backbone 130 may provide connectivity between devices located in different geographical areas and/or different types of local networks. For example, computer network 100 may include local network 160 having various devices/nodes (e.g., node 162a and node 162b) and local network 170 having various devices/nodes (e.g., router 172a, router 172b, node 174a, and node 174b) and devices/nodes 162a and 162b, respectively, as well as a data center 150 (or cloud environment) that includes servers 152a and 152b. Notably, local network 160, local network 170, and data center 150 can be located in different geographic locations.

Server 152a and server 152b can include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

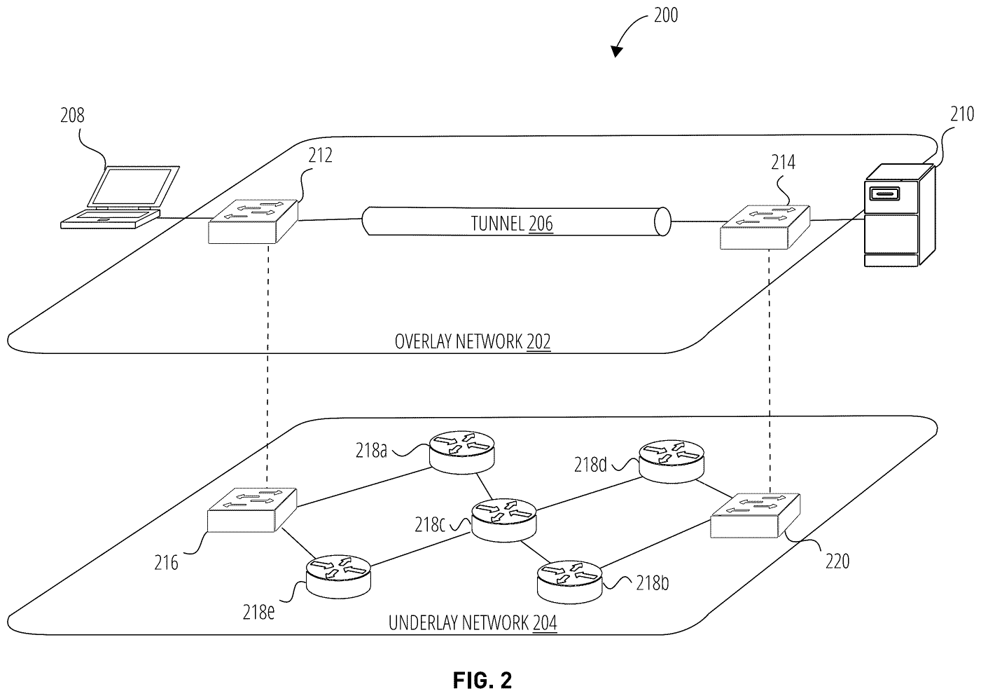

FIG. 2 illustrates a system 200 that includes an overlay network 202, which is a virtual network, that operates on an underlay network 204, which is an actual, physical network. Virtual, overlay networks can be used to implement encapsulation protocols such as VXLAN packets, Generic Routing Encapsulation (GRE) or Generic UDP Encapsulation (GUE) to encapsulate data and send it through a tunnel 206.

For example, GRE is a tunneling protocol that can encapsulate a wide variety of network layer protocols inside virtual point-to-point links or point-to-multipoint links over an Internet Protocol network. GUE provides encapsulation of user data (Application layer) into a UDP datagram (Transport layer) over IP (Network layer) inside some Data link layer protocol. Generic Network Virtualization Encapsulation (Geneve) is a network encapsulation protocol created by the IETF in order to unify the efforts made by other initiatives like VXLAN and NVGRE, with the intent to eliminate the wild growth of encapsulation protocols.

In FIG. 2, the overlay network 202 can include a virtual switch 212 that corresponds to a physical switch 216 and receives ingress data from a source node 208 (e.g., a user device, such as a laptop or smart phone) encapsulates the data and sends it through the tunnel 206 to the virtual switch 214. The virtual switch 214 corresponds to a physical switch 220 and decapsulates the received encapsulated data. After decapsulation, the virtual switch 214 sends the data to the destination node 210 (e.g., a server).

In FIG. 2, the underlay network 204 can include a physical switch 216, a physical switch 220, and a series of routers (e.g., router 218a, a router 218b, a router 218c, a router 218d, and a router 218e) that make up a network fabric.

According to certain non-limiting examples, the overlay network 202 can be a VXLAN overlay network. The virtual switch 212 and virtual switch 214 can be VXLAN Tunnel End Points (VTEPs) that provide connectivity between the overlay network 202 and the underlay network 204 networks. The VTEP can perform frame encapsulation into VXLAN packets to transport them across IP networks (e.g., the underlay network 204) and perform de-encapsulation upon exiting the VXLAN channel (e.g., tunnel 206). The underlay network 204 can operate without any awareness of the VXLAN. That is, the underlay network 204 treats the VXLAN packet just like any other normal packet. The VTEPs can be hardware based (e.g., using CISCO Nexus switches) or software based (e.g., VXLAN capable hypervisor switch in hypervisor host). For example, a hypervisor host can be instantiated in a host of a data processing unit (DPU). The VTEPs can have two interfaces: (i) a local LAN interface and an IP interface. The local LAN interface can provide local communication by bridging endpoints (e.g., the source node 208 or the destination node 210) connected to VTEPs. The IP interface can connect the underlay layer 3 network also known as transport network. The IP address are bound to the IP interface to uniquely identify VTEP in the network.

The overlay network 202 and underlay network 204 can operate independently of each other. Overlay network 202 is virtual and requires the underlay network 204 to function. Changes made in the overlay network 202, however, do not impact the underlay network 204. For example, links can be added/removed in the underlay network as long as destination is reachable by routing protocol overlay network remains unchanged.

Returning to the non-limiting VXLAN example, encapsulation (decapsulation) of VXLAN traffic can be done by the VTEPs adding (removing) additional fields. These additional field can include, e.g., (i) an external MAC address (e.g., tunnel endpoint VTEP destination media access control address); (ii) an external source MAC address (e.g., tunnel VTEP source Mac address); (iii) an external destination IP address (e.g., tunnel endpoint VTEP destination IP address); (iv) an external source IP address (e.g., tunnel VTEP source IP address); and (v) an external UDP header. VXLAN can act as an extension for VLAN (layer 2) and extend layer 2 segments so tenant workload can be distributed across physical pods in data centers. VXLAN can provides 24-bit segment ID referred as VXLAN network identifier (VNID) to enable 16 million VXLAN segments. VXLAN can transmit packets through underlay network based on layer 3 header and it takes advantage of layer 3 routing, ECMP routing and all other available routing protocols to use all paths.

VXLAN is discussed here to illustrate one non-limiting example of network virtualization. Generally, there are many examples of network virtualization, such as GRE, GUE, and Geneve. For example, a description of Geneve can be found in RFC 8926, available at https://datatracker.ietf.org/doc/rfc8926/, which is hereby incorporated in its entirety. A person of ordinary skill in the art would understand, that when the systems and methods disclosed herein use network virtualization, any of the available techniques can be used.

According to certain non-limiting examples, the virtual switch 212 and the virtual switch 214 can be implemented in hosts on DPUs that are proximate (within the network) to the source node 208 and the destination node 210

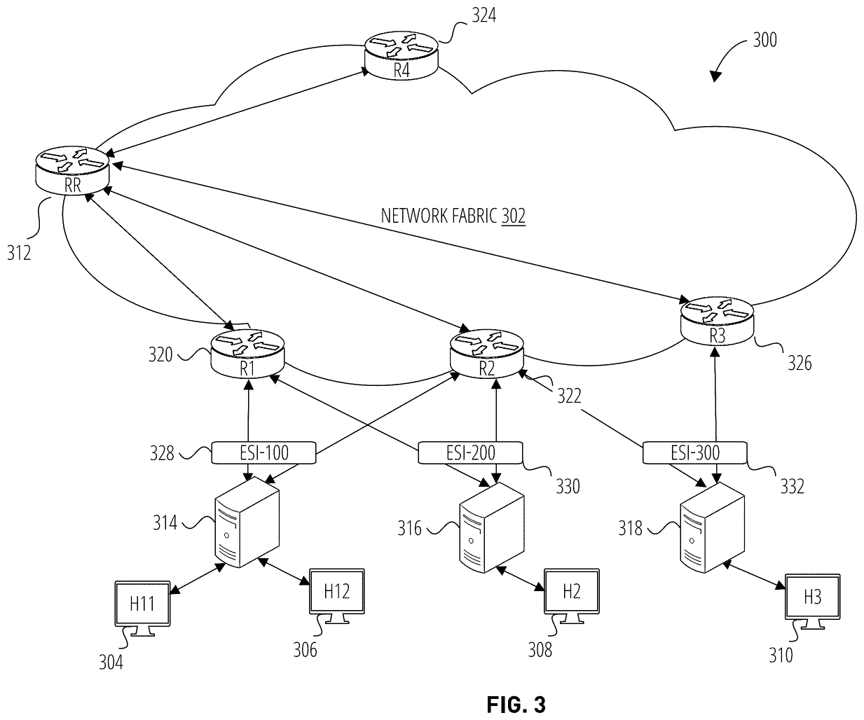

FIG. 3 illustrates a diagram of system 300 in which network traffic is routed through network fabric 302 between the respective nodes of system 300. For example, CE 314 can be a customer edge device such as a server that runs one or more applications or hosts (e.g., H11 304 and H12 306), which can be virtual machines (VMs) running on CE 314. CE 314 can be multihomed such that traffic from network fabric 302 can be routed to CE 314 via either PE 320 or PE 322. PE 320 and PE 322 are provider edge devices such as routers or switches. Similarly, H2 308 is a host running on CE 316, and CE 316 is multihomed with PE 320 and PE 322. Additionally, H3 310 is a host running on CE 318, and CE 318 is multihomed with PE 322 and PE 324.

According to certain non-limiting examples, network fabric 302 can provide a virtual network (e.g., a VXLAN network) and route reflector 312 can be a route reflector that performs an Ethernet virtual private network (EVPN) protocol. Further, PE 320, PE 322, PE 324, and PE 326 can respectively be a first router (R1), second router (R2), third router (R3), and a fourth router (R4), which are routers hosting EVPN services in network fabric 302.

Regarding the customer edge device, CE 314 can be a customer edge device that is multi-homed to R1 and R2 (i.e., PE 320 and 322), which respectively have active multi-homing. Similarly, CE 316 can be a customer edge device that is also multi-homed to R1 and R2 (i.e., PE 320 and 322), and CE 318 can be a customer edge device that is multi-homed to R2 and R3 (i.e., PE 322 and PE 324), which respectively have active multi-homing.

The Ethernet segments (ESs) in FIG. 3 are assigned Ethernet segment identifiers (ESIs). Each ES is assigned a unique non-zero identifier, which is called an ESI to represent each ES uniquely across the network. For example, the ESs for CE 314 are assigned ESI-100 328. Similarly, the ESs for CE 316 are assigned ESI-200 330, and the ESs for CE 318 are assigned ESI-300 332.

According to certain non-limiting examples, network fabric 302 can be an EVPN overlay network that is created over a layer-3 (L3) core. EVPN with multihoming provides a network architecture that is efficient and scalable and enables connecting multiple sites or data centers while allowing for redundancy and load balancing.

For example, EVPN can provide secure and private connectivity of multiple sites within an organization spread across different geographical locations. In contrast to Virtual Private LAN Services (VPLS) EVPN operates by enabling control-plane-based media access control (MAC) learning. In EVPN, PEs participating in the EVPN instances learn customer MAC routes in the control plane using a multiprotocol border gateway protocol (MP-BGP) protocol. Further, EVPN can use MAC addresses as routable addresses and distributes them to all participating PEs through the MP-BGP EVPN control plane. And EVPN allows different encapsulation mechanisms to be used in the data plane while maintaining the same control plane. EVPN also provides: (i) per flow-based load balancing; (ii) scalability; (iii) reduced operational complexity; (vi) improved network efficiency by eliminating flooding and learning; (v) provides fast reroute, resiliency, fast reconvergence during link failure; and (vi) integrates L2 and L3 VPN services.

Some of the parts of EVPN are: (1) the Ethernet segment(ES); (2) the Ethernet segment identifier (ESI); (3) Ethernet Auto Discovery Route; and (4) the designated forwarder (DF). An ES is a set of Ethernet links that connect a multihomed device. If a multi-homed device or network is connected to two or more PEs through a set of Ethernet links, then that set of links is referred to as an ES. The ES route can also referred to as Route Type 4. This route is used for designated forwarder (DF) election for broadcast, unknown-unicast and multicast (BUM) traffic. Each ES is assigned a unique non-zero identifier, which is called an ESI to represent each ES uniquely across the network. The EVPN instance (EVI) is represented by the virtual network identifier (VNI). An EVI represents a VPN on a PE router. EVIs are assigned import/export Route Targets (RTs). Depending on the service multiplexing behaviors at the User to Network Interface (UNI), all traffic on a port, on a VLAN, or on a list/range of VLANs can be mapped to a Bridge Domain (BD), which is associated to an EVI for forwarding towards the MPLS core. Ethernet Auto Discovery Route per ES (EAD/ES) can be used to converge the traffic faster during access failure scenarios. Ethernet Auto Discovery Route per EVI (EAD/EVI) can be used for aliasing and load balancing when the traffic only hashes to one of the switches. Aliasing enables load balancing the traffic to all the connected switches for a given Ethernet segment using an EAD/EVI route. Mass withdrawal can be used for fast convergence during some access failure scenarios. DF Election prevents forwarding of the loops by allowing only a single router to decapsulate and forward the traffic for a given Ethernet Segment.

According to certain non-limiting examples, at startup, PEs can exchange EVPN routes to advertise VPN membership, Ethernet segment reachability, and Redundancy Group membership.

For example, the PE can use VPN membership to discover remote PE members of a given EVI. In the case of a multicast ingress replication model, this information is used to build the PEs flood list associated with an EVI. BUM labels and unicast labels are exchanged when MAC addresses are learned. Ethernet segment reachability advertising can be used in multihoming scenarios, such that the PE auto-discovers a remote PE and the corresponding redundancy mode. According to certain non-limiting examples, in case of segment failures, PEs withdraw the routes used at this stage to trigger fast convergence by signaling a MAC mass withdrawal on remote PEs. Advertising Redundancy Group membership can be used where PEs connected to the same Ethernet segment (multihoming) automatically discover each other and elect a Designated Forwarder (DF) that is responsible for forwarding BUM traffic for a given EVI.

According to certain non-limiting examples, EVPN can operate in single-homing or dual-homing mode. In the single-homing scenario, EVPN can be enabled on a given PE, and a Route for multicast tunnel end point discovery is advertised (e.g., each PE discovers all other member PEs for a given EVPN instance). When an unknown unicast (or BUM) MAC is received on the PE, it is advertised as EVPN Route Type 2 to other PEs. MAC routes are advertised to the other PEs using EVPN Route for advertising MAC, address reachability, and/or IP/MAC binding.

According to certain non-limiting examples, in multihoming scenarios, Various EVPN route types (e.g., Route Types 1, 3, and 4) can be advertised to discover other PEs and their redundancy modes. One or more route types can be used for auto-discover of other PEs that host the same CE. The other use of this route type is to fast route unicast traffic away from a broken link between CE and PE. One or more route types can be used for electing a designated forwarder.

Returning to FIG. 3, CE 314 (and H11 304) is multihomed with PE 320 and PE 322, such that PE 324 can send data to H11 304 via either PE 320 or PE 322. The forwarding information from PE 324 to H11 304 can be based on EVPN overlay route exchange between all routers associated with network fabric 302.

The redundancy provided by multihoming a CE ensures that even if a router fails data can be rerouted to flow to the CE via another router with which the CE is homed. For example, the data to H11 304 from PE 324 (R4) can be initially routed through router R1 (i.e., PE 320). If router R1 (PE 320) goes down, interior gateway protocol (IGP) next-hop tracking enables router R4 (PE 324) to quickly detect the failure and redirect traffic to R2.

If, however, router R1 (PE 320) continues functioning but the ES link between the server (CE 314) and router R1 (PE 320) goes down, then BGP can be used to withdraw the prefix (e.g., by initiating mass withdrawal), but the withdrawal process can be subject to BGP propagation delay (e.g., BGP route reflector may be busy with other processing). For the scenario in which the ES link between PE 320 (R1) and CE 314 fails, the withdrawal process eventually informs router R4 (PE 324) of the failure, and then router R4 (PE 324) can take an action, e.g., by moving the next hop to route R2 (PE 322).

In addition to delays resulting from this withdrawal process, this withdrawal process can have the drawback of causing significant data churn when applied in a spin-leaf network architecture. For example, before router R4 (PE 324) is informed of the failure, R4 continues sending data to R1. Because the data cannot reach CE 314 from R1, the data is routed back through network fabric 302 from R1 to R2, consuming additional network bandwidth compared to if the data were initially sent to CE 314 via PE 322 (R2). This additional consumption of bandwidth can lead to oversubscription and potentially impact ongoing services. For example, the fast reroute algorithm can be programmed to use special labels to move transient traffic to a peer (in the above example, traffic is moved from R1 to R2). But in the case of a spine-leaf architecture, this FRR approach causes a sudden surge of traffic on links, potentially causing over subscription and impacting ongoing services.

The systems and methods disclosed herein provide a faster alternative for notifying a source router (e.g., PE 32)) when there is a failure at the destination router (e.g., when the link fails between PE 320 and the CE 314). To illustrate this faster alternative, consider the above-noted scenario of data from PE 324 to CE 314 that is initially routed through PE 320. In this case, an internet protocol (IP) performance measurement (PM) session is established between PE 320 (R1) and PE 324 (R4). The PM session includes messages being sent from PE 320 to PE 324, and these messages can include message fields reporting on the state of health for data flowing between the PE and the CE.

According to certain non-limiting examples, a message field can indicate the liveness of the link (e.g., an ES) between the PE and the CE. The state of health reported via the message field is not limited to the liveness of a link/ES, but that is the primary example used herein for illustrative purposes. Other examples of the state of health that can be reported via one or more message fields in a PM session can include, e.g., (1) the state of health of a host or a virtual machine that is running on a CE; (2) metrics for data transmitted via a link between the PE and the CE (e.g., jitter, delays, throughput); (3) other metrics indicating degradation in data-transmission performance, security compromise, or other issue indicating that the current PE is no longer desirable for routing data to the CE.

Returning to the above example of traffic from PE 324 (R4) to CE 314 being initially routed through PE 320 (R1) before the PE-CE link fails (e.g., the ES between PE 320 and CE 314), when a PM session is established between PE 324 and PE 320, the PM session messages can provide frequent updates of the liveness of the PE-CE link, such that upon the failure of the link PE 324 is promptly notified of the failure and immediately begins to route traffic to CE 314 through PE 322, thereby avoiding the above noted issues of delays and potential over subscription.

In one aspect, the PE monitors the state of health (e.g., liveness) of the PE-CE link (e.g., ES) to have current information of the state of health, which is then reported in the PM session messages. This monitoring of the state of health can be achieved in various ways, including, e.g., (1) a local optics check for an interface failure, (2) a local connectivity fault management (CFM) protocol, (3) a bi-directional forwarding detection (BFD) protocol, or (4) a local performance measurement session.

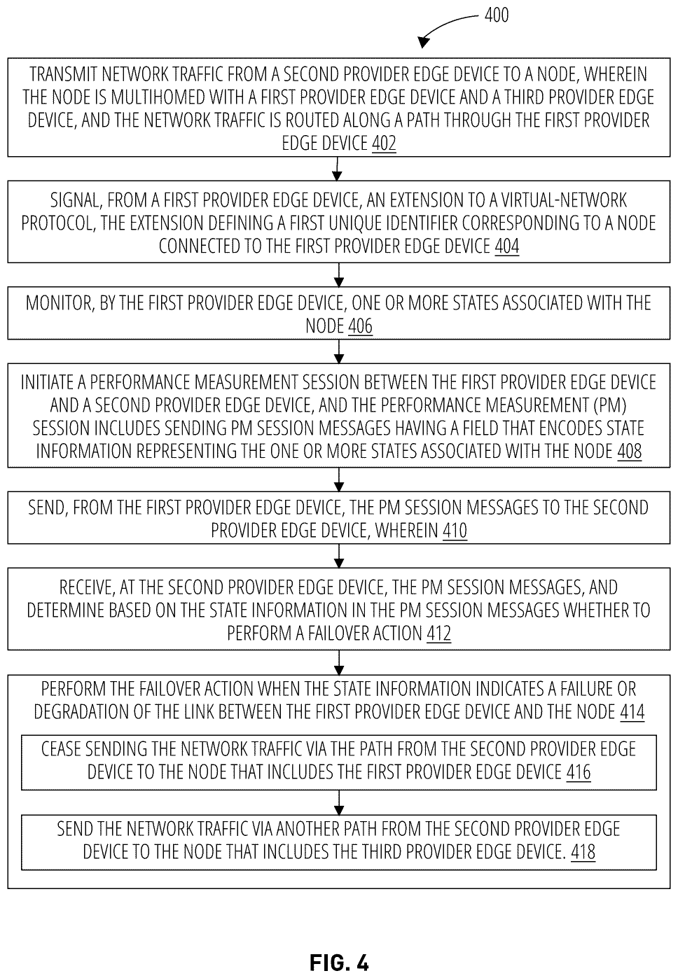

FIG. 4 illustrates an example method 400 for realizing faster convergence with multihoming based on liveness reporting using a performance measurement session in an Ethernet virtual private network (EVPN). Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, in step 402, the method includes transmitting network traffic from a provider edge (PE) device (e.g., PE 324) to a node (e.g., CE 314). For consistency, the transmitting PE device is herein referred to as the second PE device. The node is multihomed with a first PE device (e.g., PE 320) and a third PE device (e.g., PE 322). Initially, the network traffic is routed along a path through the first PE device.

According to some examples, in step 404, the method includes signaling, from the first PE device, an extension to a virtual-network protocol. The extension defines a unique identifier corresponding to a node (e.g., a CE device) that is connected to the first PE device.

For example, the virtual-network protocol can be EVPN, and the extension can be an internet protocol (IP) performance measurement (PM) session between PEs of the network fabric 302. According to certain non-limiting examples, the performance measurement session is initiated using a protocol selected from a group consisting of a Two-Way Active Measurement Protocol (TWAMP), a Simple Two-Way Active Measurement Protocol (STAMP), bi-directional forwarding (BFD) protocol.

The messages that are sent as part of the PM session can include a field (e.g., a type-length-value (TLV) field) that encodes state information, which is information regarding the state of health of communications between the first PE device and the node. For example, the field that encodes state information representing the one or more states associated with the node can be a type-length-value field that includes a value representing whether a failure has occurred with respect to the node (e.g., when the link is an ES, the failure can be that the ES is not live).

According to some examples, in step 406, the method includes monitoring, by the first PE device, one or more states associated with the node. The monitoring can be performed, e.g., using a local optics check for an interface failure, a local connectivity fault management (CFM) protocol, a bi-directional forwarding detection (BFD) protocol, or a local performance measurement session.

According to some examples, in step 408, the method includes initiating a PM session between the first PE device and the second PE device. The PM session can include sending PM session messages having a field that encodes the state information, which represents the one or more states associated with the node. As discussed above, the field in the PM session messages can be an optional TLV field that signals the liveness of an ES between a PM device and a CE device.

According to some examples, in step 410, the method includes sending, from the first PE device, the PM session messages to the second PM device.

According to some examples, in step 412, the method includes receiving, at the second provider edge device, the PM session messages, and determining based on the state information in the PM session messages whether to perform a failover action.

According to some examples, process 414 of method 400 includes performing a failover action when the state information in the received PM session messages indicates a failure or degradation of the link between the first PE device and the node. For example, when the state information indicates the liveness of an ES between a PE and a CE, the indication that the link is not live can cause the failover action of moving traffic to a next hop (e.g., another PE with which the node is homed).

According to certain non-limiting examples, process 414 can include step 416 and step 418, In step 416, the method can include ceasing to send the network traffic via the path from the second provider edge device to the node that includes the first provider edge device. In step 418, the method includes sending the network traffic via another path from the second provider edge device to the node that includes the third provider edge device.

According to certain non-limiting examples, the virtual-network protocol is an Ethernet virtual private network (EVPN) protocol on an VXLAN virtual network.

According to certain non-limiting examples, the performance measurement session is initiated using a Two-Way Active Measurement Protocol (TWAMP), a Simple Two-Way Active Measurement Protocol (STAMP), or bi-directional forwarding (BFD) protocol.

According to certain non-limiting examples, the PM session messages include a type-length-value (TLV) field that encodes the state information in a value representing a state of health associated with the node and/or communications with the node (e.g., whether a failure has occurred at the node or for communications with the node). For example, an Ethernet segment(ES) can be established to link the PE and the CE, and the TLV field can include one or more values indicating the state of health for the ES (e.g., the liveness of the ES). As another example, the CE can be a server that executes a host or VM, and the TLV field can include information of the state of health for the host or VM. Further, the state of health represented in the TLV field can be for an application running on the CE. Alternatively, the state of health represented in the TLV field can be for a group of links or for a group of applications, rather than for a single data link or a single application. According to certain non-limiting examples, the TLV field can represent the state of health of the data link by also reporting metrics other than the liveness of the data link (e.g., reporting jitter, delays, dropped packets, etc., for the data link). The PE receiving the PM session messages can use these other metrics to assess whether transmission over the data link has degraded to a point that moving to the next hop might be merited. Thus, the field in the PM session messages can be used flexibly to additionally or alternatively convey other information than the liveness of the data link.

According to certain non-limiting examples, the state information is monitored using a local optics check for an interface failure, a local connectivity fault management (CFM) protocol, a bi-directional forwarding detection (BFD) protocol, or a local performance measurement session.

According to certain non-limiting examples, the first unique identifier are provisioned manually. Alternatively, the first unique identifier can be provisioned by a controller.

According to certain non-limiting examples, the node is a client-edge device that is connected to one or more hosts of VMs. The monitoring of the state information includes monitoring liveness states of the one or more hosts, and the sending of the state information includes intermittently or periodically sending current liveness states of the one or more hosts in the PM session messages.

According to certain non-limiting examples, the field of the PM session encodes the state information, which represents the liveness states of the ES and/or the applications running on the CE, using respective binary values in the field of the PM session messages. For example, a binary value at a first bit location in the field represents a state of a first ES (or a first host), a binary value at a second bit location in the field represents a state of a second ES (or a second hos), and so forth. Additionally, a live state can be represented by a first binary value (e.g., a binary value of “1”), and a non-live state is represented by the opposite binary value (e.g., a binary value of “0”).

According to certain non-limiting examples, initiating the performance measurement session between the first PE and the second PE can include defining which entities (e.g., hosts of data links) correspond to which bit locations in the field of the PM session messages.

According to certain non-limiting examples, the PM session messages are sent along a same path as the network traffic, but the PM session messages are transmitted using separate packets from the data traffic. For example, the PM session message can be sent periodically with a period of 3.3 milliseconds. In this case, the longest delay until the transmitting PE is notified of a failure at/between the receiving CE and PE will be 3.3 milliseconds plus the propagation delay through the network fabric 302.

According to certain non-limiting examples, the first unique identifier can be signaled using BGP.

According to certain non-limiting examples, step 404 can include that the edge device hosting the ES announces the associated bit position for the given Ethernet segment. The information announcing the associated bit position can be encoded in the existing ES auto discovery (ES-AD) route as an extended community, and the extended community (EC) field can carry a bitmap representing the state information.

According to certain non-limiting examples, in cases where there are more ESs provisioned in edge devices than the total number of bits available in a single EC field (e.g., 8 octets), another field can be defined to encode the state information in a bit string which will be carried over one or more additional ECs.

For example, as illustrated in FIG. 3, PE 320 and PE 322 together with the ES auto discovery (ES-AD) route can be included in an EC, and respective bit positions in the EC can be assigned to respective ESIs.

According to certain non-limiting examples, in step 404, PM session can be initiated using a protocol such as the two-way active measurement protocol (TWAMP) or the simple two-way active measurement protocol (STAMP) between two PEs (e.g., PEs at respective ends of a tunnel in a virtual network). The PM session can be used to measure latency, jitter, packet loss, and other network characteristics/attributes between the PEs.

TWAMP is described in RFC 5357, which is incorporated herein by reference in its entirety. TWAMP extends the One-Way Active Management Protocol (OWAMP) to provide two-way or round-trip measurements instead of unidirectional capabilities. Beneficially, two-way measurements can be used to determine round-trip delays and do not require host clock synchronization. TWAMP can operate between interfaces on two PEs playing specific roles. For example, one PE can act as the TWAMP client and the other PE can act as TWAMP server. The TWAMP client performs the functions of the Control-Client and the Session-Sender. The Control-Client sets up, starts and stops the TWAMP test sessions, and the Session-Sender creates TWAMP test packets that are sent to the Session-Reflector in the TWAMP server. The TWAMP server performs the functions of the Session-Reflector and the server. The Session-Reflector sends back a measurement packet when a test packet is received, but does not maintain a record of such information, and the server manages one or more sessions with the TWAMP client and listens for control messages on a TCP port.

TWAMP uses two related protocols, running between several defined elements: (1) TWAMP-Control and (2) TWAMP-Test. TWAMP-Control initiates, starts, and ends test sessions. The TWAMP-Control protocol runs between a Control-Client element and a server element. The TWAMP-Test protocol exchanges test packets between two TWAMP elements. The TWAMP-Test protocol runs between a Session-Sender element and a Session-Reflector element.

TWAMP Light is introduced as part of RFC 5357, and STAMP is defined by RFC 8762, both of which are incorporated herein by reference in their entirety. Further, STAMP extensions for segment routing networks are defined in RFC 9503 and RFC 8972, which are incorporated herein by reference in their entirety.

According to certain non-limiting examples, protocol data unit (PDU) padding or the identification of STAMP TLV (type, length, value) can be used to encode the state information in the PM session messages (e.g., the STAMP test packet or the TWAMP test packet).

For example, the TWAMP Light test packet request and response sizes can be asymmetrical by default. The Session-Sender packet and the Session-Reflector packets can be different sizes. To allow for symmetrical packets on the wire and packet size manipulation, the Session-Sender can configure the pad-size octets command to increase the size of the packet. These octets can be added directly to the base packet. The default pattern of the padding is all zeros which can be changed using the pattern command.

As another example, the STAMP packet request and response sizes are symmetrical by default. RFC 8762 defines a structured packet that ensures this behavior. To allow for general packet size manipulation, RFC 8972 defines a PAD TLV (type, length, value). This TL V is added after the base packet. STAMP padding uses the pad-tlv-size octets command to increase the size of the packet.

According to certain non-limiting examples, the Session-Reflector can use a configuration option type twamp-light|stamp to determine its processing behavior for the test packet received from the Session-Sender. For backward compatibility, the default processing behavior is twamp-light. This type performs no TLV processing, treating any non-base packet octets as padding. If the required behavior for the Session-Reflector is to parse and process STAMP TLVs, type stamp must be used. Using this configuration, the Session-Reflector can accommodate both TWAMP Light and STAMP Session-Senders, processing the packet based on the TLV rules defined by the STAMP Optional Extensions RFC 8972. The TLV field can be used to encode the state information in the PM session messages (e.g., the STAMP test packet or the TWAMP test packet).

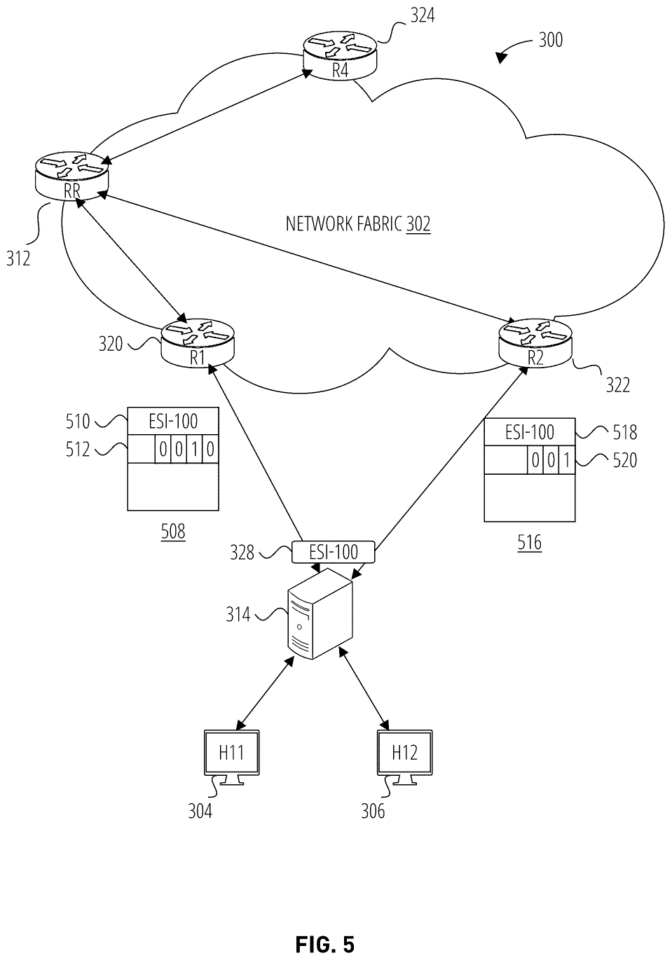

According to certain non-limiting examples, the PM session messages can carry an extra TLV field that is used to track the different Ethernet segments hosted on the endpoint (e.g., in a STAMP TLV). In the example, illustrated in FIG. 3, for example, PE 324 can initiate a PM session with bit map “0010” for PE 320 and bit map “001” for PE 322. This example is discussed more with reference to FIG. 5.

According to certain non-limiting examples, the monitoring PE (e.g., PE 320 in FIG. 3) that has the data link with the node (e.g., CE 314 in FIG. 3) locally monitors/tracks the liveness and/or state of health for the data links (e.g., ESs). Additionally or alternatively, the monitoring PE can monitor/track the liveness and/or state of health of hosts (e.g., VMs) on the node. Referring to the example in FIG. 3, PE 320 can locally track each of the Ethernet segments connected to PE 320. For example, when one or more of the tracked entities (e.g. ESs and/or hosts) undergoes a state change (e.g., an ES transitions from being live to not live), the monitoring PE detects the state change, and the state-information field of the PM sessions represent the state change by changing the value in the state-information field that represent the state that changed. For example, when the fifth bit position in the state-information field of the PM sessions represents the liveness state of a particular ES and that liveness state changes (e.g., transitions from live to not live), then the binary value of the fifth bit position is toggled to represent the changed state. That is, when any of the monitored entities has a state change, the corresponding values transmitted in the state-information field of the PM sessions is going to be SET/RESET to reflect the changed state. As discussed above, according to certain non-limiting examples, each bit position can indicate the health of the associated Ethernet segment.

According to certain non-limiting examples, a failover action is initiated according to process 414 when there is a failure or degradation to data transmission between the node (e.g., CE 314) and the monitoring PE (e.g., PE 320). The failover action can be initiated at the transmitting PE (e.g., PE 324), when the transmitting PE receives notice from the monitoring PE of the failure or degradation. This notice is communicated to the transmitting PE via the value(s) in the state-information field of the PM sessions that represent the state of health for the failed data link (e.g., ES). Returning to the example of FIG. 3, when a given data link goes down between PE 320 and CE 314, PE 320 resets the bit corresponding to the given data link in the state-information field of the PM session, which PM session as originally initiated by PE 324. For example, when a bit value of “1” represents the given data link being live, the bit value is reset to “0.” Upon receiving the PM session message with the changed bit value. PE 324 is notified of the failure, and PE 324 can now change the route for network traffic from PE 324 to CE 314 by marking a next hop PE (e.g., PE 320) as an invalid next hop for every host that was learned on that interface.

According to certain non-limiting examples, the notification of failure received at the transmitting PE via the PM session messages enabled faster convergence times. The transmitting PE learns of the failure in a fraction of a second and adjusts the next hop accordingly. Thus, the systems and methods disclosed herein avoid BGP propagation delays.

According to certain non-limiting examples, the PM sessions can be point-to-point (P2P) PM sessions.

According to certain non-limiting examples, the PM sessions can be point-to-multipoint (P2MP) PM sessions. For example, a P2MP PM session can be initiated for a set of Ethernet segments hosted at the monitoring PE, such that every PE transmitting to nodes that are multihomed with the monitoring PE can join the P2MP session, thereby enabling faster convergence on failure for all transmitting PEs that have joined the P2MP session.

According to certain non-limiting examples, the state of health reported in the state-information field of the PM session messages is not limited to reporting liveness. For example, the state of health reported in the state-information field can include ES latency, jitter, and packet loss information, which is conveyed from the monitoring PE to the transmitting PE via the PM session messages. For example, the monitoring PE (e.g., PE 320) can measure latency, jitter, and packet loss of the ES to the CE, and these values can be measured using a local PM session or other monitoring mechanism (e.g., CFM, BFD, local optics check, etc.). Further, additional values representing the measured latency, jitter, and packet loss can be added to the PM session messages using a TLV. When received by the transmitting PE (e.g. PE 324) the additional information can be used to determine metrics that are used by the transmitting PE to select low-latency paths to the CE.

According to certain non-limiting examples, in process 414, the failover action can be taken in response to the packet loss information and/or latency information in the state of health conveyed by the PM session messages. For example, the failover action can be performed when the liveness information indicates an absence of communication between the monitoring PE and the node. Alternatively or additionally, the failover action can be performed when the liveness information indicates non-liveness of a first ethernet segment between the node and the monitoring PE. Alternatively or additionally, the failover action can be performed when the packet loss information indicates traffic loss between the monitoring PE and the node has exceeded a first predefined threshold (e.g., a loss threshold). Alternatively or additionally, the failover action can be performed when the jitter or latency information indicates that data transmission between the monitoring PE and the node has exceeded a second predefined threshold (e.g., a jitter or latency threshold).

According to certain non-limiting examples, in the state-information field of the PM session message, the liveness of each ES can be represented in a bit mask by the bit values at respective bit positions. For example, the binary value of “1” can represent that that corresponding data link (e.g., ES) is live, and the binary value of “0” can represent that that corresponding data link (e.g., ES) is not live. The bit value a first bit position can represent the state of a first ES, the bit value a second bit position can represent the state of a second ES, and so forth. The bit-mask coding scheme can be used to minimize the number of bytes used to encode the liveness information of multiple ESs. That is, by using the bit mask, the systems and methods disclosed herein can avoid using 10 bytes of the encoding per Ethernet segment. Alternatively, the state of health information can be encoded less compactly in the PM session message. For example, the state of health information for each Ethernet segment using an entire TLV field of 10 bytes.

According to certain non-limiting examples, the systems and methods disclosed herein can be used in a centralized gateway case to support a virtual ethernet segment, such as a 16k Ethernet segment (e.g., ASR9k current scale) and each physical port may be mapped to multiple virtual ethernet segments. In this case, using the smallest entity helps the systems and methods disclosed herein to scale better.

According to certain non-limiting examples, in step 404, the signaling of a procedure extension in EVPN is used to define a unique identifier that is to be used in PM sessions for a given tuple of {BGP next hop, Ethernet Segment}. For example, the unique identifier can be provisioned manually. Alternatively, the unique identifier can be provisioned by a controller.

FIG. 5 illustrates an example of advertising bit assignments and the PM session messages (e.g., announcement 508 and announcement 516) that are generated as part of a PM session. For example, among the other fields included in a PM session message, announcement 508 includes an Ethernet segment identifier (ESI) field (i.e., ESI field 510) and an extended community (EC) field (i.e., EC field 512). Similarly, announcement 516 also includes an ESI field (i.e., ESI field 518) and an EC field (i.e., EC field 520).

As discussed above, an Ethernet segment(ES) is a set of Ethernet links that connects a multihomed device, such as CE 314, which is multihomed with PE 320 and PE 322. When, as in FIG. 5, a multi-homed device or network is connected to two or more PEs through a set of Ethernet links, then that set of links is referred to as an ES. According to certain non-limiting examples, the ES route can also be referred to as Route Type 4. According to certain non-limiting examples, this route can be used for designated forwarder (DF) election for BUM traffic.

According to certain non-limiting examples, an EC field can be used to encode the state information. BGP can be used to define an extended community for routes. The regular community attribute is four octets. Networking enhancements, such as VPNs, have functionality requirements that can be satisfied by an attribute such as a community. In certain embodiments, extended communities can be used when the 4-octet community value does not provide enough expansion and flexibility to accommodate VPN requirements. An extended community is an 8-octet value that is also divided into two main sections. The first 2 octets of the community can encode a type field while the last 6 octets can carry a unique set of data in a format defined by the type field. Extended communities have the benefit of providing a larger range for grouping or categorizing communities.

The ES in FIG. 5 is assigned an ESI (i.e., ESI-100 328), which is a unique non-zero identifier. The ESI uniquely represents the ES across the network.

According to certain non-limiting examples, the overhead needed to encode the state information can be minimized by using the smallest entity for encoding the state information. For example, when the state information is the liveness of an entity (e.g., an ES or a host), the smallest entity for encoding is a single bit because the entity is either live (e.g., represented by a bit value “1”) or not live (e.g., represented by a bit value “0”). When the PM session is initiated with a Next Hop, the systems and methods disclosed herein can be provisioned to monitor each ES provisioned in that Next Hop. When an attribute, such as liveness, has only two possible values (e.g., live and not live), the smallest entity that can represent is attribute is a bit. Accordingly, each bit position can be assigned to a respective ES of the Next Hop. For example, the scope of each bit would be {Next hop, Ethernet Segment}. Consequently, the same bit position for different Next Hops can be used to represent different ESs. For example, in FIG. 5, PE 320 has announced that ESI-100 328 is associated with the second bit position, whereas PE 322 has announced that ESI-100 328 is associated with the first bit position.

As discussed above with reference to method 400 illustrated in FIG. 4, the edge device hosting the ES (i.e., the monitoring PEs: PE 320 and PE 322) announces which bit positions are associated with which ESs. This information regarding the correspondence between ESs and bit position can be encoded in the existing ES-AD route as an extended community (EC). The EC can carry the bitmap.

For example, in FIG. 5, the value “1” represents that an ES is live. As discussed above, PE 320 has associated ESI-100 328 with the second bit position, whereas PE 322 has associated ESI-100 328 with the first bit position. Announcement 508 from PE 320 includes ESI field 510 and EC field 512. ESI field 510 indicates that the announcement is for ESI-100 328, and EC field 512 indicates that the ES labeled by ESI-100 328 is associated with the second position.

Similarly, announcement 516 from PE 322 includes ESI field 518 and EC field 520. ESI field 518 indicates that the announcement is for ESI-100 328, and EC field 520 indicates that the ES labeled by ESI-100 328 is associated with the first position.

In cases where more ES are provisioned in edge devices than the total number of bit positions available in a single EC, the ESs can be associated with bit positions in more than one EC. For example, when the number of bits in an EC is N and the number of ES is more than N but less than or equal to 2N, the ESs can be subdivided into two sets, with the first set being associated with bit position in a first EC and the second set being associated with bit positions in a second EC.

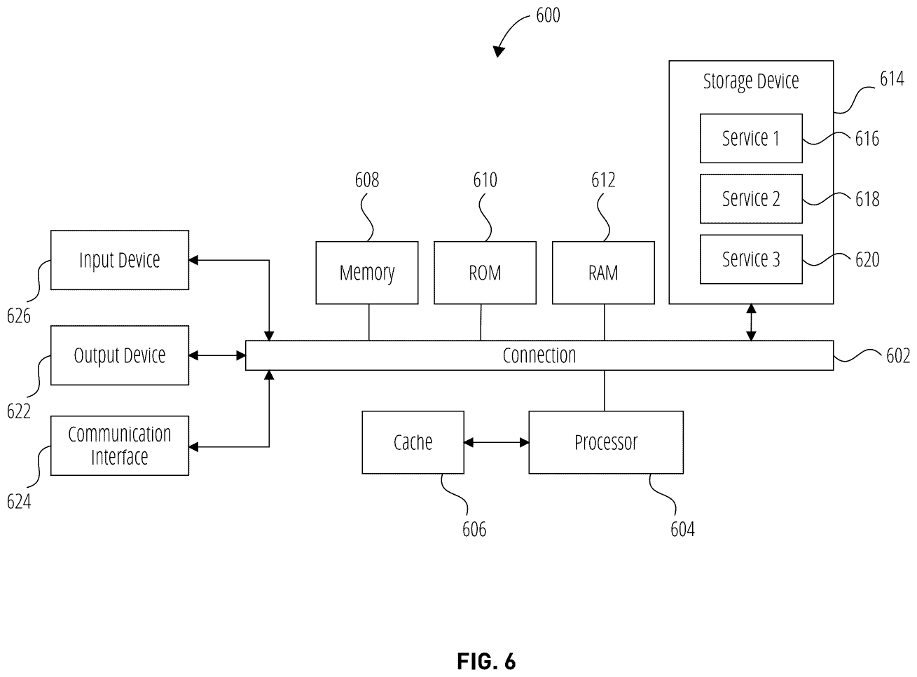

FIG. 6 shows an example of computing system 600. The computing system 600 can be the elements of computer network 100, system 200, and/or system 300, for example. The computing system 600 can perform the functions of one or more of the servers, switches, routers, data center fabric, or other parts of one of the data centers disclosed herein. The computing system 600 can be part of a distributed computing network in which several computers perform respective steps in methods 400 and/or the functions of computer network 100, system 200, and/or system 300. The computing system 600 can be connected to the other parts of the distributed computing network via connection 602 or communication interface 624. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (e.g., processor 604) and connection 602 that couples various system components including system memory 608, such as ROM 610 and RAM 612 to processor 604. Computing system 600 can include a cache of high-speed memory 606 connected directly with, in close proximity to, or integrated as part of processor 604. Processor 604 may essentially be a completely self-contained computing system, containing multiple cores or processors, a bus, memory controller, cache, etc. A multi-core processor may be symmetric or asymmetric.

Processor 604 can include any general-purpose processor and a hardware service or software service, such as services 616, 618, and 620 stored in storage device 614, configured to control processor 604 as well as a special-purpose processor where software instructions are incorporated into the actual processor design.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include a communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
signaling, from a first provider edge device, an extension to a virtual-network protocol, the extension defining a first unique identifier corresponding to a node connected to the first provider edge device;
monitoring, by the first provider edge device, one or more states associated with the node;
initiating a performance measurement session between the first provider edge device and a second provider edge device, and the performance measurement session includes sending one or more messages having a field that encodes state information representing the one or more states associated with the node; and
sending, from the first provider edge device, the one or more messages to the second provider edge device, wherein
traffic from the second provider edge device to the node are routed along a path that includes the first provider edge device.

2. The method of claim 1, wherein the one or more states associated with the node are a state of an ethernet segment that connects the node with the first provider edge device, host states of one or more hosts on the node, application states of one or more applications running on the node, or VM states of one or more virtual machines (VMs) on the node.

3. The method of claim 1, wherein a first ethernet segment connects the node to the first provider edge device, and the one or more states associated with the node are a liveness state of the first ethernet segment.

4. The method of claim 1, wherein the first unique identifier is manually provisioned or the first unique identifier is provisioned by a controller.

5. The method of claim 1, wherein:
the virtual-network protocol is an Ethernet virtual private network (EVPN) protocol on an VXLAN virtual network,
the performance measurement session is initiated using a protocol selected from a group consisting of a Two-Way Active Measurement Protocol (TWAMP), a Simple Two-Way Active Measurement Protocol (STAMP), bi-directional forwarding (BFD) protocol,
the one or more messages are messages of the performance measurement session, and the field is a type-length-value field that includes a value representing whether a failure has occurred with respect to the node, and
monitoring the one or more states associated with the node is performed using a local optics check for an interface failure, a local connectivity fault management (CFM) protocol, a bi-directional forwarding detection (BFD) protocol, or a local performance measurement session.

6. The method of claim 1, wherein the node is multihomed at the first provider edge device and a third provider edge device, and the node is advertised, via the virtual-network protocol, to the second provider edge device as receiving traffic either through the first provider edge device or through the third provider edge device.

7. The method of claim 6, wherein, when the state information indicates a failure of a connection between the first provider edge device and the node,
ceasing to receive the traffic along the path from the second provider edge device to the node including the first provider edge device, and
receiving the traffic along another path from the second provider edge device to the node including the third provider edge device.

8. The method of claim 1, wherein:
the node is a client-edge device that is connected to one or more hosts,
monitoring one or more states state associated with the node includes monitoring liveness states of the one or more hosts, and
sending the state information includes intermittently sending current liveness states of the one or more hosts in the one or more messages,
the one or more messages are messages sent in the performance measurement session that encode the state information of the liveness states using respective binary values in the field of the messages, wherein a binary value at a first bit location in the field represents a state of a first host of the one or more hosts, a live state of the first host being represented by a first binary value at the first bit location, and a non-live state of the first host being represented by a second binary value at the first bit location, and
initiating the performance measurement session between the first provider edge device and the second provider edge device includes defining which of the one or more hosts correspond to which bit locations in the field of the messages sent in the performance measurement session.

9. A method comprising:
receiving, at a second provider edge device, a signal including one or more instructions to apply an extension to a virtual-network protocol, the extension defining a first unique identifier corresponding to a node connected to a first provider edge device;
instantiating a performance measurement session between the second provider edge device and the first provider edge device, wherein the performance measurement session includes receiving at the second provider edge device one or more messages having a field that encodes state information representing one or more states associated with the node;
sending traffic from the second provider edge device to the node, wherein the traffic are routed on a path from the second provider edge device to the node including the first provider edge device; and
performing, at the second provider edge device, a failover action when a value of the field indicates a failure associated with the node or degradation of communications between the first provider edge device and the node.

10. The method of claim 9, further comprising:
receiving, at the second provider edge device, information that the node is multihomed with the first provider edge device and a third provider edge device, such that a first ethernet segment connects the node to the first provider edge device, a second first ethernet segment connects the node to the third provider edge device; and
performing the failover action includes:
ceasing to send the traffic via the path from the second provider edge device to the node including the first provider edge device; and
sending, from the second provider edge device, the traffic via another path from the second provider edge device to the node including the third provider edge device.

11. The method of claim 9, wherein:
the node is multihomed with the first provider edge device and with a third provider edge device, and
the failover action is for the second provider edge device to direct traffic to the third provider edge device, when the one or more messages indicate the failure of communication between the first provider edge device and the node.

12. The method of claim 11, wherein the failover action is performed when the value of the field indicates the failure associated with the node is (i) an absence of communication between the first provider edge device and the node, (ii) an indication of non-liveness of a first ethernet segment between the node and the first provider edge device, (iii) an indication of traffic loss between the first provider edge device and the node has exceeded a first predefined threshold, or (iv) an indication of jitter between the first provider edge device and the node has exceeded a second predefined threshold.

13. A system comprising:
a first provider edge device comprising:
a first processor; and
a first memory storing instructions that, when executed by the first processor, configure the first provider edge device to:
signal, to a second provider edge device, an extension to a virtual-network protocol, the extension defining a first unique identifier corresponding to a node connected to the first provider edge device;
monitor one or more states associated with the node;
initiate a performance measurement session between the first provider edge device and a second provider edge device, wherein the performance measurement session includes sending one or more messages having a field that encodes state information representing the one or more states associated with the node; and
send, to the second provider edge device, the one or more messages to the second provider edge device, wherein
traffic from the second provider edge device to the node are routed along a path that includes the first provider edge device.

14. The system of claim 13, wherein the one or more states associated with the node are a state of an ethernet segment that connects the node with the first provider edge device, states of one or more hosts on the node, states of one or more applications on the node, or states of one or more virtual machines on the node.

15. The system of claim 13, wherein the first unique identifier is manually provisioned, or the first unique identifier is provisioned by a controller.

16. The system of claim 13, wherein:
the virtual-network protocol is an Ethernet virtual private network (EVPN) protocol on an VXLAN virtual network,
the performance measurement session is initiated using a protocol selected from a group consisting of a Two-Way Active Measurement Protocol (TWAMP), a Simple Two-Way Active Measurement Protocol (STAMP), bi-directional forwarding (BFD) protocol,
the one or more messages are messages of the performance measurement session, and the messages include a type-length-value field that includes a value representing whether a failure has occurred with respect to the node, and
monitoring the one or more states associated with the node is performed using a local optics check for an interface failure, a local connectivity fault management (CFM) protocol, a bi-directional forwarding detection (BFD) protocol, or a local performance measurement session.

17. The system of claim 13, wherein the node is multihomed at the first provider edge device and a third provider edge device, and the node is advertised, via the virtual-network protocol, to the second provider edge device as receiving the traffic either through the first provider edge device or through the third provider edge device.

18. The system of claim 13, wherein:
the node is a client-edge device that is connected to one or more hosts,
monitoring one or more states state associated with the node includes monitoring liveness states of the one or more hosts, and
signaling the state information representing the one or more states associated with the node includes intermittently signaling current liveness states of the one or more hosts, the one or more messages are messages sent in the performance measurement session that encode information of the liveness states using respective binary values in a field of the messages, wherein a binary value at a first bit location in the field represents a state of a first host of the one or more hosts, a live state of the first host being represented by a first binary value at the first bit location, and a non-live state of the first host being represented by a second binary value at the first bit location, and
the instructions stored in the first memory further configure the first provider edge device to initiate the performance measurement session between the first provider edge device and the second provider edge device includes defining which of the one or more hosts correspond to which bit locations in the field of the messages sent in the performance measurement session.

19. The system of claim 13, further comprising:
a second provider edge device comprising:
a second processor; and
a second memory storing instructions that, when executed by the second processor, configure the second provider edge device to:
receive, from the first provider edge device, a signal including one or more instructions to apply the extension to the virtual-network protocol;
instantiate the performance measurement session between the second provider edge device and the first provider edge device;
send the traffic to the node, the traffic being routed along the path from the second provider edge device to the node including the first provider edge device;
receive, from the first provider edge device, the one or more messages; and
perform a failover action when the state information encoded in the field of the one or more messages indicates a failure associated with the node or a degradation of communications between the first provider edge device and the node.

20. The system of claim 19, wherein:
the node is multihomed with the first provider edge device and with a third provider edge device,
the failover action is for the second provider edge device to direct the traffic to the third provider edge device, when the one or more messages indicate the failure of communication between the first provider edge device and the node, and
the failover action is performed when the field indicates the failure associated with the node is (i) an absence of communication between the first provider edge device and the node, (ii) an indication of non-liveness of a first ethernet segment between the node and the first provider edge device, (iii) an indication of traffic loss between the first provider edge device and the node has exceeded a first predefined threshold, or (iv) an indication of jitter between the first provider edge device and the node has exceeded a second predefined threshold.
